(19) United States
(12) Patent Application Publication
(10) Pub. No.: US 2021/0316531 A1
(43) Pub. Date: Oct. 14, 2021

(54) MULTI-LAYERED TUBE INCLUDING A NON-METALLIC CORE LAYER, AND METHODS THEREOF

(71) Applicant: Material Sciences Corporation, Canton, MI (US)

(72) Inventors: Peter Isaac Bortell, Tecumseh, MI (US); Jason Schoonover, Milan, MI (US); Bryan Joseph Tullis, Commerce Twp, MI (US)

(21) Appl. No.: 17/226,465

(22) Filed: Apr. 9, 2021

Related U.S. Application Data
(60) Provisional application No. 63/007,446, filed on Apr. 9, 2020.

(51) Int. Cl. B32B 15/08; B32B 15/18; B32B 15/20; B32B 38/00

(52) U.S. Cl. CPC B32B 15/08; B32B 15/18; B32B 15/20; B32B 2307/732; B32B 2597/00; B32B 2250/40; B32B 2250/03; B32B 38/0036

(57) ABSTRACT

The teachings herein relate to tubes formed of a composite material and improved methods for forming the tubes. The composite material includes metallic layers and a core layer interposed between the metallic layers. The core layer preferably reduce the transmission of sound and or heat between the two metallic layers.

### FIELD

The teachings herein relate to multi-layered tubes having two spaced apart metallic layers and methods for producing the tubes. The tube preferably includes a core layer including a non-metallic material. The core layer preferably reduces the transmission of sound and/or heat between the spaced apart metallic layers.

### BACKGROUND

Tubes formed of metallic materials often require sound dampening coverings or insulation for reducing the transmission of sound or heat from the inside of the tube to the outside of the tube.

Multi-layered composite material having good sound attenuation properties are often used in stamped parts. However, these materials are difficult to form into tubes due to core layers that cannot be welded.

Tubes formed of a monolithic metal may be relatively expensive due to a need for one surface of the tube to be corrosion resistant, even though such a feature is not necessary for the entire tube and/or for the other surface. For example, tubes are often made of stainless steel even though this material is only required for one surface.

There is a need for new composite tube materials for reducing or eliminating sound transmission (e.g. from an inside of the tube to an outside of the tube). There is a need for a new composite tube material for reducing heat transmission (e.g. from an inside of the tube to an outside of the tube). There is a need for a composite tube having a seam that is durable. There is a need for a new method for forming a composite tube. There is a need for a new method for joining the edges of a composite tube for forming a seam along the length of the tube. There is also a need for composite tubes that are less expensive than certain monolithic metal tubes. There is a need for tubes and methods having any combination of two or more of the above features.

### SUMMARY

One or more of the aforementioned needs can be achieved using a composite tube and/or method according to the teachings herein.

One aspect of the invention is directed at a tube comprising: a first metallic layer; a second metallic layer arranged over the first metallic layer; a core layer (preferably a core layer of a nonmetallic material, such as a polymeric material or a glass material) interposed between the first metallic layer and the second metallic layer; and a seam region connecting ends of the first metallic layer and/or connecting ends of the second metallic layer; wherein the tube has a wall thickness, and the seam region extends the wall thickness and is free of the core layer material.

Another aspect of the invention is directed at a tube comprising: a first metallic layer; a second metallic layer arranged over the first metallic layer; a core layer (preferably a core layer of a nonmetallic material, such as a polymeric material or a glass material) interposed between the first metallic layer and the second metallic layer; and a seam region connecting ends of the first metallic layer and connecting ends of the second metallic layer, with core layer material between the connected ends; wherein the tube has a wall thickness, and the seam region extends the wall thickness, wherein the first metallic layer has a width (e.g., in a direction of a circumference of the tube) that is greater than a width of the second metallic layer.

Any of the aspects of the teachings herein may be characterized by one or any combinations of the following features: the first metallic layer is a steel or aluminum, the second metallic layer is a steel or aluminum, and the tube has a cylindrical shape; the layer of the polymeric material extends a circumference of the tube, except for the seam region; or the layer of the polymeric material contacts a surface of the first metallic layer and a surface of the second metallic layer.

Another aspect according to the teachings herein is directed at a method of preparing a tube of any of claims 1 through 4, comprising the steps of: bending a blank or strip of a composite material for contacting a first edge region and a second edge region, wherein the first and second edge regions of the blank or strip are spaced apart by a width of the blank or strip; and joining the first edge region and the second edge region; wherein the blank includes a first metallic layer, a second metallic layer, and a core layer of a non-metallic material interposed between the first and second metallic layers (preferably the blank or strip is a continuous strip).

Any of the aspects according to the teachings herein may be further characterized by one or any combination of the following: the blank or strip is characterized by a width of the second metallic layer that is greater than a width of first metallic layer; the first edge region of the blank or strip is characterized by a first edge of the first metallic layer and a first edge of the second metallic layer, wherein the first edge of the metallic layers on parallel, spaced apart planes; the first edge of one or both of the metallic layers is orthogonal to a face surface of the blank or strip; the step of joining includes joining a first edge of the first metallic layer directly to a second edge of the second metallic layer; the blank or strip is characterized by a width of the second metallic layer that is the same as a width of the first metallic layer; the blank or strip is characterized by the first edge region being free of the polymeric material, the second edge region being free of the non-metallic material, or both; the first edge region and/or the second edge region of the blank or strip is characterized by an edge surface having an acute angle (preferably an angle of 10° to 80°) with respect to a direction of a thickness of the blank or strip; the first edge region and the second edge region mate along a plane parallel to a thickness of the tube in the seam region; the first edge region and the second edge region mate along a plane that is tilted (by greater than 0°, by 2° or more, by 5° or more, or by 10° or more) relative to a plane parallel to a thickness of the tube in the seam region; the mating of the first edge region and the second edge region in the seam region is jagged; the blank or strip is characterized by one of the metallic layers having a longer width than the other metallic layer, and the method includes a step of bending the longer width to cover an edge of the other metallic layer; the edge regions are joined by welding; the core layer is a formed of a material that does not weld using resistance welding (preferably a polymeric material or a glass material); the step of joining includes welding a first surface of one of the metallic layers to a first edge of the other metallic layer and welding a second surface of the one metallic layer to the second edge of the other metallic layer; or the blank or strip is characterized by a first metallic layer having perforations for forming a predetermined break point and the method includes trimming the first metallic layer along the break point.

### BRIEF DESCRIPTION OF DRAWINGS

FIG. 1 is an illustrative drawing showing features of a blank or strip including a composite material.

FIG. 2 is an illustrative drawing of a composite tube including a seam running a length of the tube.

FIG. 3 is a top view of a tube shaped from a composite material having layers with the same width.

FIG. 4 is an illustrative drawing showing features of a blank or strip of a composite material that is free of core layer material in one or the edge regions.

FIG. 5 is an illustrative drawing showing features of a blank or strip of a composite material that is free of core layer material in both of the edge regions.

FIG. 6 is an illustrative drawing of a blank or strip having an edge that is angled. The angled edge may form an angle ß 64, relative to a thickness direction.

FIG. 7 is a cross-sectional view showing illustrative features of a blank or strip having both edges cut at an angle, in opposite directions.

FIG. 8 is a cross-sectional view showing illustrative features of a blank or strip having both edges cut at an angle, in opposite directions, and having metallic layers that do not contact the core material in the edge region.

FIG. 9 is a cross-sectional view showing illustrative features of a blank or strip having both edges cut at an angle, in opposite directions, and having a metallic layer that does not contact the core material in the edge region.

FIG. 10 is a cross-sectional view showing illustrative features of a blank or strip having both edges cut at an angle, in the same direction.

FIG. 11 is a cross-sectional view showing illustrative features of a blank or strip having both edges cut at an angle in the same direction and having metallic layers that do not contact the core material in the edge region.

FIG. 12 is a cross-sectional view showing illustrative features of a blank or strip having both edges cut at an angle, in the same direction, and having a metallic layer that does not contact the core material in the edge region.

FIG. 13A is a drawing illustrating features of a blank or strip having a tab in the edge region. The tab may be formed by one of the metallic layers having a width longer than the other metallic layer.

FIG. 13B illustrates a tab that has been bent (for example at an angle of about 90°). The bent tab may cover a core material and/or cover an edge of the other metallic layer.

FIG. 13C is a drawing illustrating a blank or strip having tab regions (offsets) on each of the metallic layers. FIG. 13D is a drawing illustrating a blank or strip having tab regions that include a locking feature for locking the two metallic layers.

FIG. 14 is a drawing of an illustrative blank or strip having one or more rows of perforations, slits, or grooves in a metallic layer for defining a predetermined break point.

FIG. 15 is an illustrative cross-sectional view of a blank or strip passing through a pair of rollers for obtaining an initial curvature.

FIG. 16 is an illustrative cross-sectional view of a blank or strip having been formed into a generally tube shape and passing through forming rollers. The forming rollers may exert a pressure to bring the edge regions together for forming a seam.

FIGS. 17A, 17B, 17C, and 17D are illustrative cross-sectional views of blanks or strips before forming a seam and having an edge region that is free of core material. The edge region may include a bent tab connected to one of the metallic layers (FIG. 17A). The edge region may include metallic layers having edges that are generally parallel to the thickness direction (FIG. 17B). The edge region may have a relatively low thickness (compared to other regions), such as by compressing or contacting the two metallic layers in the edge region (FIG. 17C). The edge region may have angled edges that mate (FIG. 17D).

FIG. 18 is an illustrative cross-section of a tube having a seam with excess material in seam region.

FIG. 19 is an illustrative cross-sectional view of a blank or strip having edge regions where the metallic layers are forced towards each other and/or contact each other.

FIG. 20 is an illustrative cross-sectional view of a blank or strip having edge regions where the metallic layers are forced towards each other and/or contact each other.

FIG. 21 is an illustrative drawing showing features of forming a tube using a strip arranged in a helical manner.

### DETAILED DESCRIPTION

The composite tubes according to the teachings herein may be formed from a composite material including two metallic layers and a core layer interposed between the two metallic layers. The core layer preferably includes, consists substantially of, or consists entirely of one or more non-metallic materials.

The first metallic layer and the second metallic layer may be any metal that can be joined by heat and/or pressure, such as by a welding process. Preferred metals include steel and aluminum. The first and second metallic layers may be formed of the same material or from different materials. Preferably, the first and second metallic layers are formed from the same material and/or from materials that can be welded together. For example, the first and second metallic layers may be formed from the same grades of steel or from different grades of steel that can be welded together. As another example, the first and second metallic layers may be formed from the same aluminum alloy or may be formed from different aluminum alloys that can be welded together. It is also possible that one of the metallic layers is formed of a steel and the other is formed of a non-ferrous metal. It is also possible that one of the metallic layers is formed of an aluminum, and the other metallic layer is formed of a non-aluminum metal. For example, one metallic layer may include a steel layer and the other metallic layer may include an aluminum layer. The composite tube may include one metallic layer (e.g., a metallic sheet) that is corrosion resistant and another metallic layer that is formed of a different metal or alloy having less corrosion resistant. For example, the other metallic layer may be formed of a less expensive metallic metal or alloy. Preferably the metallic layer having good corrosion resistance properties has a lower thickness than the other metallic layer. By way of example, the metallic layer having good corrosion resistance may include or consist of stainless steel, and the other metallic layer may be of a metal or alloy different than a stainless steel (preferably, the other metallic layer is formed of a different steel or a metal or metal alloy that can be welded or joined to stainless steel.

The first metallic layer and the second metallic layers preferably are formed from metallic sheets. The metallic sheets preferably are provided as rolls so that a roll of the composite material can be produced. The first metallic layer and the second metallic layer may have the same thickness or may have different thickness. Preferably a ratio of the thickness of the two metallic layer (i.e., the thinnest metallic layer to the thickest metallic layer) is about 0.1 or more, about 0.2 or more, about 0.4 or more, about 0.50 or more, about 0.75 or more, about 0.8 or more, or about 0.90 or more. A ratio of the thickness of the two metallic layers may be about 1.00 or less. It will be appreciated that in some applications it may be desirable for the first metallic layer (e.g., on the inner side of the tube) to have a wall thickness greater than the wall thickness of the second metallic layer (e.g., on the outer side of the tube). In other applications, it may be desirable for the second metallic layer to have a wall thickness greater than a wall thickness of the first metallic layer. Preferably, the total thickness of the first and second metallic layers is about 0.25 mm or more, more preferably about 0.50 mm or more, even more preferably about 0.70 mm or more, and most preferably about 0.80 mm or more. The total thickness of the first and second metallic layers preferably is about 12 mm or less, more preferably about 8.0 mm or less, even more preferably about 6.0 mm or less, even more preferably about 4.0 mm or less, and most preferably about 2.5 mm or less.

The first metallic layer, the second metallic layer, or both, may have a metal or metal-containing coating on one or more surfaces. The coating may be a deposited layer or a layer of a plating. The coating may provide a desired appearance or a desired functional feature to a surface. The coating may reduce or eliminate corrosion of the surface. The coating may be a zinc-containing coating. Preferably the coating (e.g., the zinc-containing coating) is only on one of the surfaces of a metallic layer. Preferably a surface of the first metallic layer and/or a surface of the second metallic layer is substantially or entirely free of a coating. More preferably, a surface of one of the metallic layers facing towards the other metallic layer is substantially or entirely free of a coating. Most preferably, both metallic layers have one or both facing surfaces that are substantially or entirely free of a coating (e.g., substantially or entirely free of a zinc-containing coating). For example, the only metal surface(s) of the tube having a coating may be an inner surface of the tube, an outer surface of the tube, or both. It will be appreciated that a surface is substantially free of a zinc-containing coating when the amount of the coating is i) about 12 g/m² or less, about 6 g/m², about 4 g/m² or less, or about 3 g/m² or less; or ii) a ratio of an amount of zinc-coating on the surface to an amount of zinc-coating on the other surface of the metallic layer is about 40% or less, about 30% or less, about 20% or less, about 10% or less, or about 5% or less.

The core layer provides a separation between the two metallic layers. The core layer, preferably reduces or eliminates transmission of sound and/or heat between the two metallic layers. The core layer preferably includes one or more non-metallic material. The amount of non-metallic material in the core layer may be about 50 volume percent or more, about 70 volume percent or more, 80 volume percent or more, about 90 volume percent or more, or about 95 volume percent or more, based on the total volume of the core layer. The amount of non-metallic material in the core layer may be about 100 volume percent or less, or about 99 volume percent or less. Examples of materials that may be employed in the core layer include polymers, oligomers, cross-linkable and/or polymerizable compounds, glasses, ceramic materials, woven or non-woven fabrics, organic materials, clays, mineral fillers, or any combination thereof. The core layer preferably includes a polymer or other viscoelastic material capable of absorbing sound or preventing the transfer of sound.

The core layer preferably fills a substantial amount of the space between the first and second metallic layers (excluding regions near a tube seam that may be free of core layer material, as discussed herein). Preferably the core layer material fills about 30% or more of the volume, more preferably about 50% or more of the volume, even more preferably about 75% or more of the volume, even more preferably about 90% or more of the volume, and most preferably about 95% or more of the volume between the first and second metallic layers. The amount of any voids in the core layer and/or between the metallic layers may be about 70 volume percent or less, about 50 volume percent or less, about 25 volume percent or less, about 10 volume percent or less or about 5 volume percent or less, based on the total volume between the first and second metallic layers.

The thickness of the core layer preferably is about 0.5 mm or less, more preferably about 0.4 mm or less, even more preferably about 0.30 mm or less, even more preferably about 0.20 mm or less, and most preferably about 0.15 mm or less. The thickness of the core layer preferably is about 0.01 mm or more, about 0.02 mm or more, about 0.03 mm or more, about 0.04 mm or more, or about 0.05 mm or more.

The first metallic layer (e.g., the first metal sheet) preferably is an innermost layer of the tube. The second metallic layer (e.g., the second metal sheet) preferably is an outermost layer of the tube. The composite tubes according to the teachings herein includes at least the first metallic layer, the second metallic layer and the core layer. Although a composite tube may include one or more additional layers, the use of the core layer may eliminate the need for a sound dampening layer (e.g., in the interior or exterior of the tube). As such, the composite tube may consist essentially of, or entirely of the first and second metallic layers and the core layer.

The composite tubes according to the teachings herein includes a seam region where one or more of the metallic layers are joined together. The seam region preferably is a small section of the tube. It may be possible for the seam region to allow the transmission of some heat or sound between the two metallic layers. As such, the seam region should be sufficiently small so that such transmission is reduced as compared to an all-metal tube. For example, the size of the seam region may be about 10 percent or less of the circumference of the tube, preferably about 6 percent or less, more preferably about 4 percent or less, and most preferably about 3 percent or less. If the seam region is too small, the pipe may not be sufficiently strong and may fail under pressure or handling. Preferably the seam size of the seam region is about 0.3 percent or more, about 0.5 percent or more, or about 1 percent or more of the circumference of the tube.

In order to achieve a strong seam, it has been determined that one or more steps must be taken to reduce or eliminate the core layer material from the seam region.

Furthermore, when the width of a strip or blank is rolled to form a circumference of a tube, the circumference of an outer portion of the tube (e.g., where the second metallic layer is located) will generally be greater than the circumference of and inner portion of the tube (e.g., where the first metallic layer is located). If the width of the two metallic layers are identical, then it is difficult to have both 1) edges of the first metallic layer meet together and 2) edges of the second metallic layer meet together.

Thus, prior attempts to achieve a composite tube have resulted in weak seams and new methods for producing a composite tube was needed.

The method may include a step of cutting a blank or strip for a tube, the blank or strip having a first face surface for facing towards an outside of the tube and a second face surface for facing towards an inside of the tube.

The composite tube is preferably produced from a blank of the composite material having a generally rectangular shape or from a strip (e.g. a continuous strip) of the composite material having a generally constant width. The composite tube is preferably produced from a continuous strip of the composite material.

The blank or strip may have a length for defining a length of the tube, a thickness for defining a thickness of the tube, and a width for defining a circumference of the tube. The blank or strip may have a first edge region and a second edge region spaced apart in the width direction. The method may include a step of bending the blank or strip so that the first edge region is brought towards or contacts the second edge region. The method may include a step of joining together the first edge regions and the second edge regions. The first and second edge regions may be joined together directly or may be joined together indirectly. The first and second edge regions may be joined together with the aid of a joining material.

The blank or strip may include one or two tabs (i.e. offsets). Blanks or strips having two offsets will generally have the offsets on opposite ends (i.e., along the width direction) of the blank/strip. If there are two tabs, they may both be on the same metallic layer, or they may be on different metallic layers. Two tabs may have the same length or may have different lengths. When tabs are on different metallic layers, the metallic layer that will be on the outside of the tube preferably has an offset that is longer than the offset on the other metallic layer.

The blanks or strips according to the teachings herein may include one or more locking features that provide a locking mechanism between the metallic layers.

The blanks or strips according to the teachings herein may be employed to form a tube where the metallic layers are joined together directly and/or joined together with one more additional metallic components. The joining may be with any type of joint. Preferably, the when forming the tube, the metallic layers of the blank or strip are joined by one or more lap joints, one or more butt joints, one or more joggle lap joints, one or more half-lap joints, one or more T-joints, one or more, tongue and grove joints, or any combination thereof.

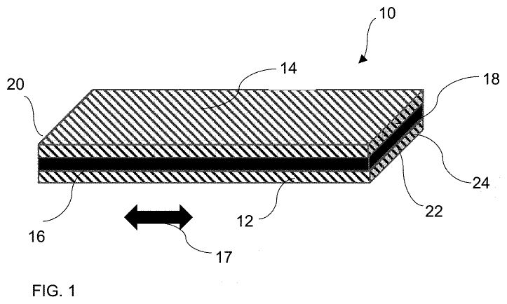

FIG. 1 illustrates a blank or strip 10 of a composite material including a first metallic layer 12, a second metallic layer 14 and a core layer 16 between the first metallic layer and the second metallic layer. The blank or strip 10 may be characterized by a width direction 17. In forming a tube, a seam may be formed by joining together a first edge region 18 and a second edge region 20 which are spaced apart in the width direction 17. The first edge region may include a first edge 22 of the first metallic layer 12 and a first edge 24 of the second metallic layer 14. The second edge region may include a second edge of the first metallic layer and a second edge of the second metallic layer.

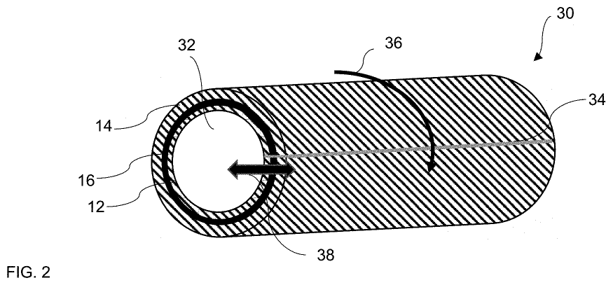

FIG. 2 is a drawing of an illustrative composite tube 30 including a first metallic layer 12 a second metallic layer 14, and a core layer 16. The composite tube has a seam region 34 where the edges are joined together. The composite tube 30 may have an opening 32 for carrying a fluid. The composite tube is characterized by a circumference direction 36 and a thickness direction 38 at the seam 34.

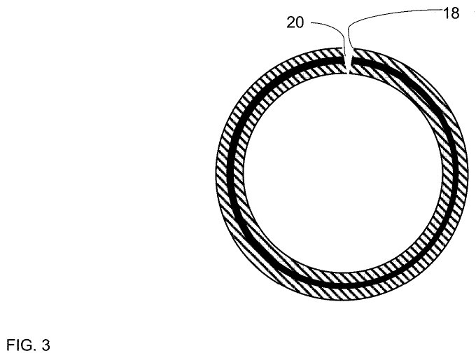

FIG. 3 is a top view of a rolled composite material, which has been rolled to form a tube having an opening. FIG. 3 shows the circumference of the tube, the opening in the center, and the multi-layered structure. When rolling a composite material having first metallic layer and second metallic layer with the same width so that the first edge region 18 contacts the second edge region 20, the edges of the second metallic layer may not contact due to the larger circumference of the tube. Thus, there may be a gap, such as illustrated in FIG. 3.

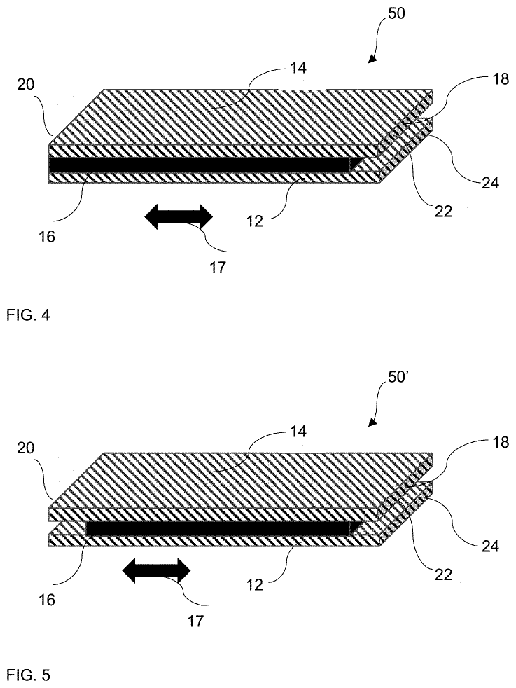

In order to obtain a stronger seam, the blank or strip may be free of the core material in one of the edge regions, such as illustrated in FIG. 4. Preferably the blank or strip is free of the core material in both the first and second edge regions, such as illustrated in FIG. 5. Such a blank or strip may be obtained from a composite material that is produced with regions that are free of the core layer or by removing core layer material from the edges to be joined.

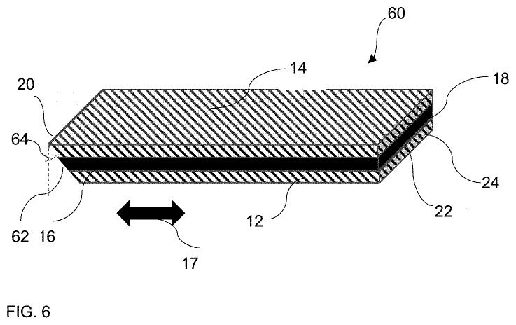

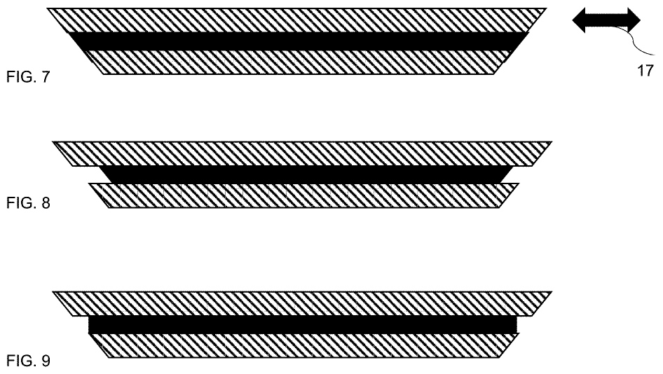

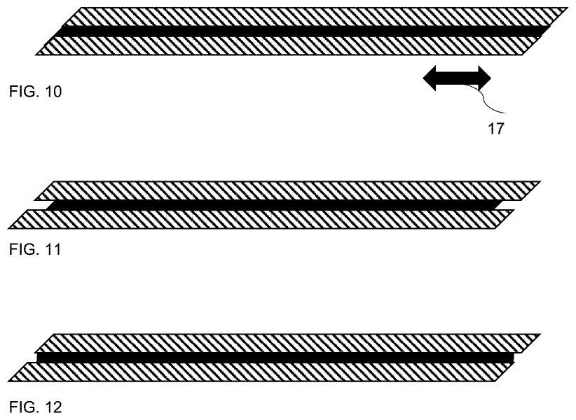

In order to align the edge surface before forming a seam, it may be advantageous to cut one or both of the edge regions at an angle. An example of an edge region that is cut at an angle is shown in FIG. 6. This figure illustrates features of a blank or strip having an edge that is angled and having an angled edge with an angle ß 64, relative to a thickness direction. If both edges are cut at an angle, the angle may be in the same direction or may be in opposite directions. FIGS. 7, 8, and 9 are cross-sectional views of blanks or strips of a composite material perpendicular to the length direction and showing the width and thickness. An edge region may be cut at an angle ß relative to the thickness direction. Preferably, both edge regions are cut at the same angle, but in opposite directions so that the first metallic layer has a width that is shorter than the second metallic layer. Preferably, a portion of the bottom surface of the second metallic layer (near one or both edges) does not contact core material, such as illustrated in FIG. 9. Preferably, a portion of the top surface of the first metallic layer (near one or both edges) also does not contact core material, such as illustrated in FIG. 8. As such, the core layer may be recessed from one or both edges. FIGS. 10, 11, and 12 are cross-sections of blanks or strips of a composite material perpendicular to the length direction and showing the width and thickness having edges of the blank or strip cut in the same direction. As illustrated in FIGS. 11 and 12, one or both of the metallic layers may be free of contact with the core material in the edge region.

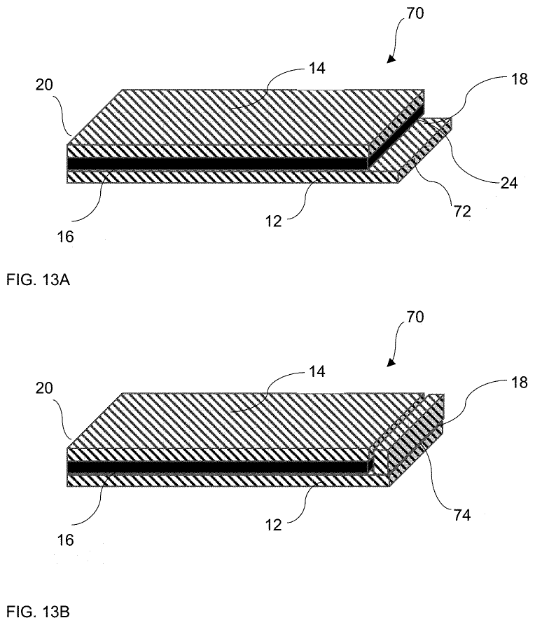

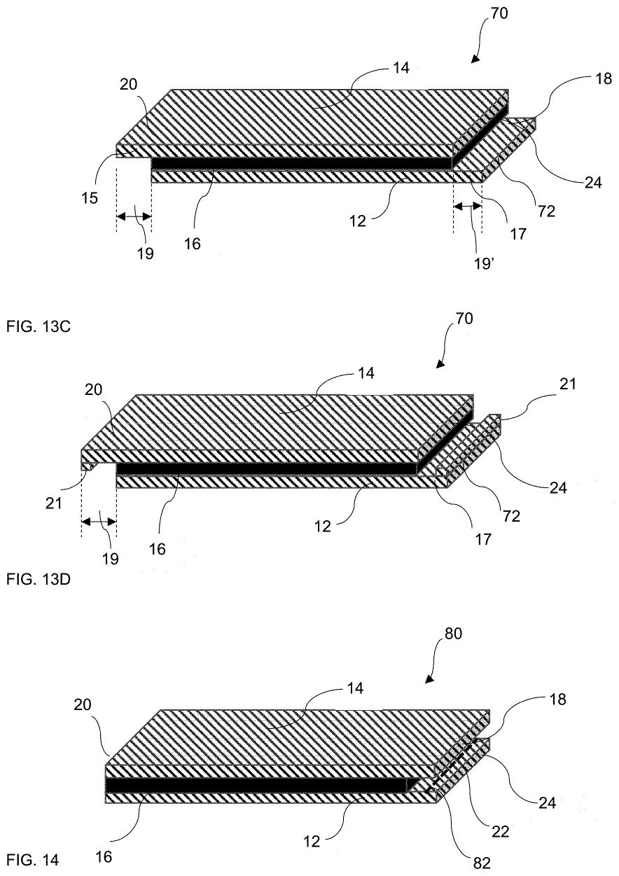

The blank or strip may include one or tabs for forming the seam. A tab may be a section of a metallic layer in an edge region that is longer than the other metallic layer. FIG. 13A is an illustrative drawing of a blank or strip having one metallic layer with a width longer than the other metallic layer for forming a tab region. The tab region may be bent at an angle of about 90°, such as illustrated in FIG. 13B for forming an edge that is free of the core material. During a seaming process, this tab region may be joined to the other metallic layer and to the metallic layers on the other edge. It will be appreciated that both edge regions may have a tab and the seam may include the joining of both tabs.

FIG. 13C is an illustrative drawing of a blank or strip having a first metallic layer 12 with a width longer than a second metallic layer at one end for forming an offset 15, and the second metallic layer having a width longer than the first metallic layer for forming a second offset 17 on the other end. Each offset may be considered as a tab region. The two offsets may be the same or different in length, 19, 19′. Preferably the metallic sheet that is on or towards the outer surface of the tube has a larger offset. Each offset is preferably uniform in length. The length of each offset preferably is predetermined. For example, the length of each offset may be determined so that a strength of the tube is achieved and of a predetermined length. If the offset is too long, then the transmission of heat or sound between the two metallic layers may be too high. The offsets may have one or more locking features 21 for providing a locking mechanism between the two metallic layers, such as illustrated in FIG. 13D.

One or both of the metallic layers may include a row of perforations or slits, or a groove for defining a predetermined break point. For example, as shown in FIG. 14, a predetermined break point may be positioned near an edge region. A predetermined break point may be employed for making a blank or strip having metallic layers with different widths.

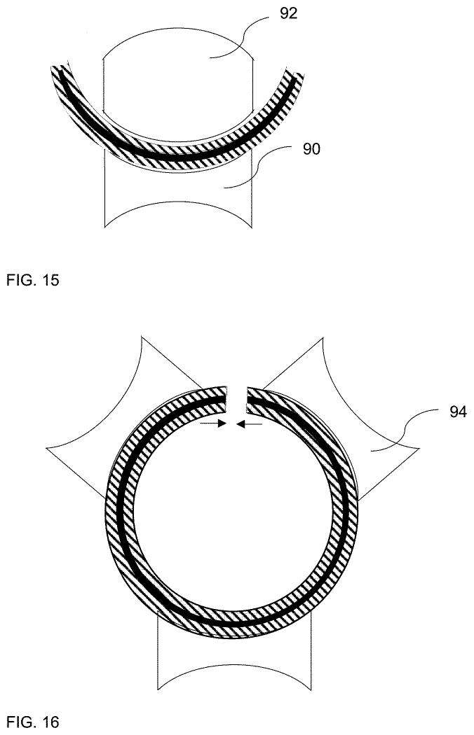

The composite tube may be formed by formed by passing the blank or strip through a series of rolls. For example, the blank or strip may pass between a pair of rolls, one having a concave surface and another having a convex surface, for providing an initial curvature to the blank or strip, such as illustrated in FIG. 15.

Two edges may be forced together for joining the edges and forming a seam. The edges may be heated before or after being brought in contact. Any method of heating may be employed. However, high speed heating methods (e.g., using high electric currents and or induction heating are preferred). The edges may be forced together using one roller on the right side of the seam region and a second roller on the left side of the seam region. One or more additional rollers may be used to support the tube being rolled or to reduce slipping of an edge. For example, a roller may be positioned opposite the seam. By way of example, a set of three rollers may be employed, for forming a seam, such as illustrated in FIG. 16. Each of the rollers preferably has a concave surface for mating against the surface of the workpiece and/or compressing the workpiece.

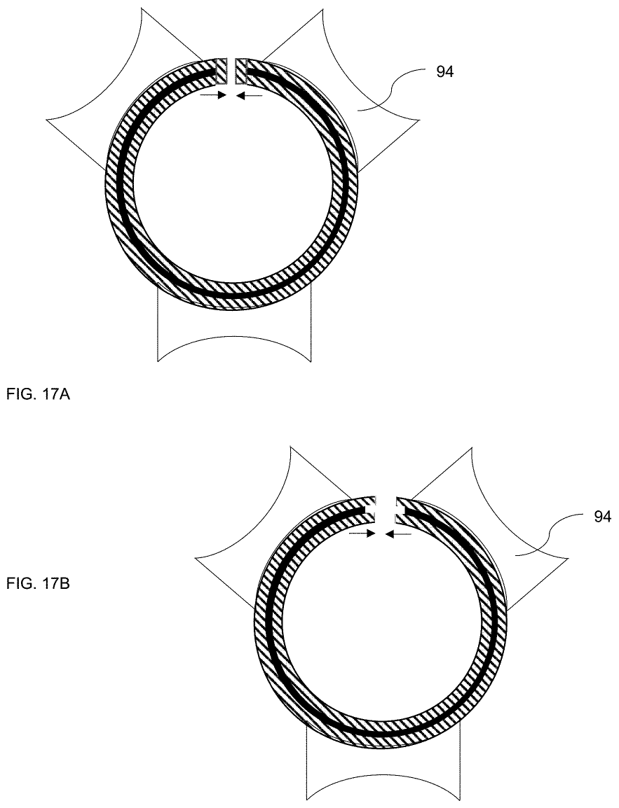

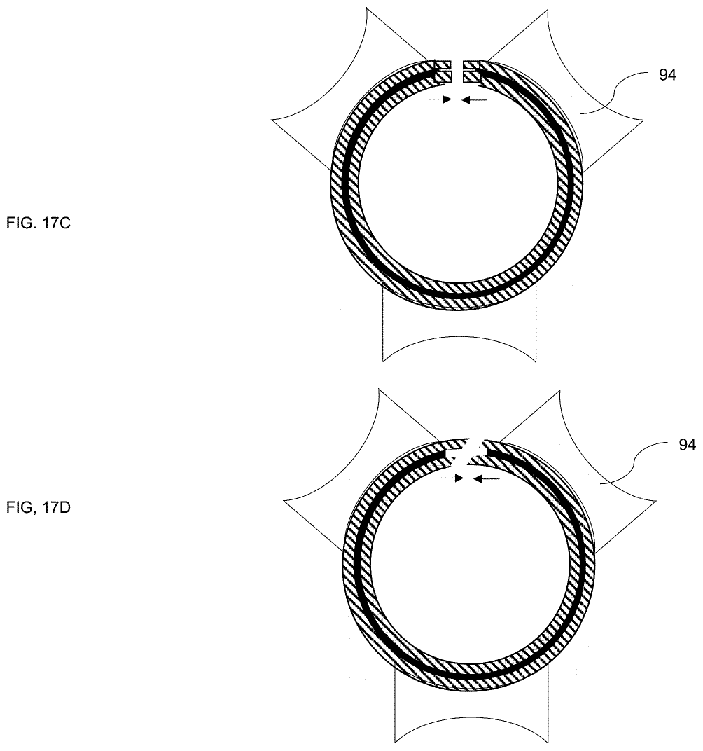

The formed blank or slit may have edge regions that are free of the core material such as illustrated in FIGS. 17A, 17B, 17C, and 17D. As illustrated in FIG. 17A, the edge surface may include a tab region that is bent from one of the metallic layers. The edge surfaces, just prior to joining, may be generally parallel. The edge surfaces just prior to joining may be parallel to the thickness direction. The edge surface just prior to joining may be angled relative to the thickness direction. The metallic layers in the edge region may be forced towards each other or may even contact each other so that the thickness at the edge region is less than the thickness away from the edge region. The edge region may include a bent tab connected to one of the metallic layers (FIG. 17A). The edge region may include metallic layers having edges that are generally parallel to the thickness direction (FIG. 17B). The edge region may have a relatively low thickness (compared to other regions), such as by compressing or contacting the two metallic layers in the edge region (FIG. 17C). The edge region may have angled edges that mate (FIG. 17D).

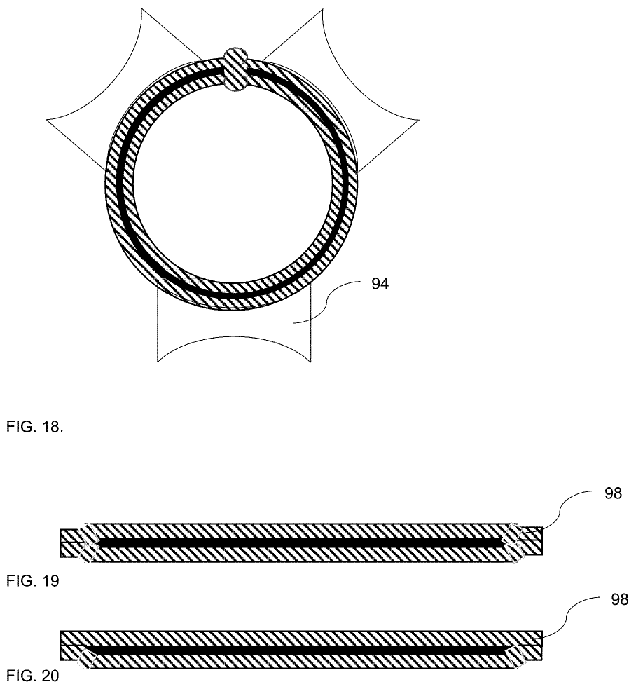

After heating the edge region and applying pressure to form a seam, the seam region may become thicker from the flow of the molten metallic material, such as illustrated in FIG. 18. The process may include a step of trimming or otherwise removing this excess material from the interior surface, the exterior surface, or both. Preferably enough of this excess material is removed so that the surface is smooth and or the thickness of the seam is the same as the thickness of other regions of the tube.

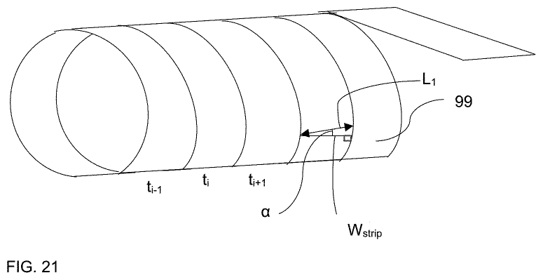

The process may include a step of forming an edge region of the blank or strip so that the first and second metallic layers are brought together and/or contact each other in the region, such as illustrated in FIGS. 19 and 20. For example, the edge region may be formed so that any gap (e.g., a void gap which is substantially free of or totally free of the core layer) between the two metallic layers is reduced or eliminated. When the metallic layers are brought together, the edge region of the blank or strip will have a wall thickness that is less than a wall thickness of a region of the material having the core layer.

It will be appreciated that the core layer may be a relatively thin layer, so that any difference in the thickness in wall thickness in a region without the core layer compared with a region with the core layer is small. For example, the difference in the wall thickness may be about 20% or less, about 10% or less, about 5% or less, or about 3% or less. (The percent difference in the wall thickness may be: (100%×(tₘₐₓ−tₘᵢₙ) tₘₐₓ, or 100%×t_{core} Aₘₐₓ). Tₘₐₓ may be the thickness of the region of the composite with core material, tₘᵢₙ may be the thickness of the region without core material, t_{core} may be the thickness of the core layer.

The metallic layers of an edge region may be brought together before the metal strip or blank is rolled into a tube shape, during the rolling of the metal strip or blank into a tube shape, or after rolling the strip or blank into a tube shape. It will be appreciated that regions of the metal layers without core material may be brought together during a process of preparing a coil or sheet of composite material. For example, a coil or sheet may have periodic depressions (i.e., where the thickness of the material is reduced), typically in the form of channels or grooves running a length of the coil or sheet.

When forming an edge region to bring together or contact the two metal layers, care should be taken to avoid or reduce the forcing of material from the core layer into the edge region. For example, the forming can occur from a distal portion or area and work towards a more central area abutting the core layer.

It will be appreciated that a composite tube may also be formed by arranging a strip of the composite material in a helical manner such as illustrated in FIG. 21. Each turn or winding 99 of the tube may be defined by approximately one width of the strip. The edges (on each side of the width) of the strip may be welded or otherwise joined to edges from adjacent turn. The leading edge of turn t may be welded to the trailing edge a previous turn (e.g., tᵢ₋₁). The trailing edge of turn t may be welded to a leading edge of a subsequent turn (e.g., tᵢ₊₁). When formed in such a helical manner, the tube is preferably formed from a single strip.

The process of forming the composite tube may include a step of cutting the first edge and/or the second edge so that they are perpendicular to the face surface (i.e., parallel to the thickness direction) when the strip or blank is formed into a tube shape.

The process may include a step of passing the strip or blank (e.g., the composite material) through one or more. Preferably the process includes passing the material through a series of rollers.

The method may include one or more steps of applying a pressure and/or heat to contacted edges for welding a seam. For example, the edges may be heated with inductive heat. As another example, the edges may be welded using resistance welding. A preferred resistance welding method is resistance seam welding.

The method may include a step of passing the welded tube through a smoother for removing a “harsh” region created by the weld.

The tube may be formed into a circular shape.

The circular shaped tube may be further formed by passing through rollers for creating a non-circular shape. For example, the tube may be placed through a rectangular or square opening defined by four rollers.

The circular shaped tube may be formed by passing the blank through a series of dies. For example, the blank may be formed into a U-shaped using a U-shaped die. The U-shaped part may be then inserted into a circular (o-shaped) die for forming into a circular tube. It will be appreciated that similar dies, other dies, or additional dies may be used in the forming process.

The blank or strip preferably is a continuous strip formed from a roll or sheet of a composite material (including the metallic layers and the core layer).

The process may include a step of slitting or otherwise cutting the roll or sheet of composite material to a strip having a predetermined width for a single tube. It will be appreciated that the roll or sheet of composite material may be slit or cut into a plurality of strips for forming multiple tubes.

The roll or sheet of composite material and/or a strip of composite material may be processed to clean a surface, remove corrosion on a surface, or both. For example, a roll of composite material and/or a continuous strip of composite material may undergo a step of pickling. The roll or sheet of composite material and/or a strip of composite material may be processed to achieve one or any combination of the following improvements: to increase the surface smoothness, to increase the flatness of the metal, to reduce the thickness to a predetermined value, or to improve the uniformity of the thickness. For example, a roll or sheet of composite material and/or a strip of composite material may undergo a step of passing through a leveling device.

The method may include a step of cutting the tube to a predetermined length.

The process may include a step of annealing and/or quenching the tube.

The process may include a step of trimming bulges and/or burr from inside and/or outside of the tube.

The method may include a step of passing the tube through calibration rolls.

May include a step of drawing the tube to reduce the thickness of the tube. Before and/or after drawing, the tube may be annealed.

The tube may be formed by passing through a drawing die, and/or by passing through rolls. Forming may be used to change the shape of the tube and/or to change the thickness of the tube. The resulting tube may have any exterior shape. Examples of shapes of a tube include a triangular shape, a rectangular shape (e.g., a square shape), an oval shape, an elliptical shape, or a circular shape.

It is also possible to prepare tubes by arranging a strip of composite material into a helical shape where each turn represents a diameter of the tubes and the width of the strip is proportional to the period or spacing of each turn (i.e., the contribution of each turn towards the length of the tube):
L₁=Wₛₜᵣᵢₚ/cos α, where L₁ is the increase in the length of the tube with each turn of the helix, Wₛₜᵣᵢₚ is the width of the strip being joined, and a is the angle of the helix.
   Each of the edges of one turn may be welded to an edge of an adjacent turn.

The method may include a step of cutting a roll of a composite material into a plurality of strips.

The method may include a step of flattening and/or cleaning a blank or strip prior to rolling or forming.

### EXAMPLES

Example 1. A blank of a composite is cut having a core a first steel layer of about 0.6 mm, a second steel layer of about 0.6 mm and a polymeric core layer of about 0.03 mm. The steel layers are electrogalvanized on one surface (the outer surfaces of the composite blank) with a zinc coating of about 60 g/m². The other surfaces (which contact the polymeric core layer) are substantially free of the zinc coating (about 3 g/m² or less of zinc coating). The blank has a 3 mm region at each of the mating edges which is free of the core material. The blank is formed into a U-shape using a first die. The U-shape part is then put into an o-shaped die to form a cylinder. The mating edges of the cylinder are then welded together using resistance seam welding. Three additional cylinders are prepared using the same method. The cylinders are uniformly shaped with a circular cross section and the seam is inform and without defects.

Example 2. The blank of Example 1 is tested for weldability by welding the edge region using resistance seam welding. The seam is uniform and without defects.

Example 3. Example 2 is repeated except using a blank having steel layers that have are electrogalvanized (60 g/m253) on both surface. The seam is not uniform and there are openings.

### REFERENCE NUMERALS

10 blank or strip for forming a tube
12 first metallic layer
14 second metallic layer
16 core layer
17 width direction of the blank
18 first edge region
20 second edge region
22 first edge of the first metallic layer
24 first edge of the second metallic layer
30 tube
32 opening
34 seam region
36 circumference direction.
38 thickness direction at seam
50 blank or strip having an edge region free of core layer material
50′ blank or strip having both edge regions free of core layer material
60 blank or strip having an edge that is angled
62 angled edge
64 angle ß
70 blank or strip having an edge region that includes a tab (e.g., consists of a tab) of only
one of the metallic layers, which may be bent.
72 tab region
74 tab region with a bent tab
80 blank or strip having a perforations, slits or other features for a predetermined break.
82 perforations, slits or other features for effecting a predetermined break.
90 concave roll
92 convex roll
94 holder for seaming or joining (e.g., jig or vice for hold and applying pressure to the tube)
98 edge region where first and second metallic layers are brought together to reduce or remove any gap between the two metallic layers (e.g., in an edge region that is free of core material).
99 winding of a strip

What is claimed is:

1. A tube comprising:
a. a first metallic layer;
b. a second metallic layer arranged over the first metallic layer;
c. a core layer (preferably a core layer of a nonmetallic material, such as a polymeric material or a glass material) interposed between the first metallic layer and the second metallic layer; and
d. a seam region connecting ends of the first metallic layer and/or connecting ends of the second metallic layer; wherein the tube has a wall thickness, and the seam region extends the wall thickness and is free of the core layer material.

2. A tube comprising:
a. a first metallic layer;
b. a second metallic layer arranged over the first metallic layer;
c. core layer (preferably a core layer of a nonmetallic material, such as a polymeric material or a glass material) interposed between the first metallic layer and the second metallic layer; and
d. a seam region connecting ends of the first metallic layer and connecting ends of the second metallic layer, with core layer material between the connected ends; wherein the tube has a wall thickness, and the seam region extends the wall thickness,
wherein the first metallic layer has a width (e.g., in a direction of a circumference of the tube) that is greater than a width of the second metallic layer.

3. The tube of claim 1, wherein the first metallic layer is a steel or aluminum, the second metallic layer is a steel or aluminum, and the tube has a cylindrical shape.

4. The tube claim 1, wherein the layer of the polymeric material extends a circumference of the tube, except for the seam region.

5. The tube of claim 4, wherein the layer of the polymeric material contacts a surface of the first metallic layer and a surface of the second metallic layer.

6. A method of preparing a tube of claim 1, comprising the steps of:
bending a blank or strip of a composite material for contacting a first edge region and a second edge region, wherein the first and second edge regions of the blank or strip are spaced apart by a width of the blank or strip; and
joining the first edge region and the second edge region;
wherein the blank includes a first metallic layer, a second metallic layer, and a core layer of a non-metallic material interposed between the first and second metallic layers (preferably the blank or strip is a continuous strip).

7. The method of claim 6, wherein the blank is characterized by a width of the second metallic layer that is greater than a width of first metallic layer.

8. The method of claim 6, wherein the first edge region of the blank or strip is characterized by a first edge of the first metallic layer and a first edge of the second metallic layer, wherein the first edge of the metallic layers on parallel, spaced apart planes.

9. The method of claim 8, wherein the first edge of one or both of the metallic layers is orthogonal to a face surface of the blank.

10. The method of claim 6, wherein the step of joining includes joining a first edge of the first metallic layer directly to a second edge of the second metallic layer.

11. The method of claim 6, wherein the blank is characterized by a width of the second metallic layer that is the same as a width of the first metallic layer.

12. The method of claim 11, wherein the blank is characterized by the first edge region being free of the polymeric material, the second edge region being free of the non-metallic material, or both.

13. The method of claim 6, wherein the first edge region and/or the second edge region of the blank or strip is characterized by an edge surface having an acute angle (preferably an angle of 10° to 80°) with respect to a direction of a thickness of the blank or strip.

14. The method of claim 6, wherein the first edge region and the second edge region mate along a plane parallel to a thickness of the tube in the seam region.

15. The method of claim 6, wherein the first edge region and the second edge region mate along a plane that is tilted (by greater than 0°, by 2° or more, by 5° or more, or by 10° or more) relative to a plane parallel to a thickness of the tube in the seam region.

16. The method of claim 6, wherein the mating of the first edge region and the second edge region in the seam region is jagged.

17. The method of claim 6, wherein the blank or strip is characterized by one of the metallic layers having a longer width than the other metallic layer, and the method includes a step of bending the longer width to cover an edge of the other metallic layer.

18. The method of claim 6, wherein the edge regions are joined by welding.

19. The method of claim 6, wherein the core layer is formed of a material that does not weld using resistance welding (preferably a polymeric material or a glass material).

20. The method of claim 6, wherein the step of joining includes welding a first surface of one of the metallic layers to a first edge of the other metallic layer and welding a second surface of the one metallic layer to the second edge of the other metallic layer.

21. The method of claim 6, wherein the blank is characterized by a first metallic layer having perforations for forming a predetermined break point and the method includes trimming the first metallic layer along the break point.
